(19) United States
(12) Patent Application Publication
(10) Pub. No.: US 2021/0198460 A1
(43) Pub. Date: Jul. 1, 2021

(54) PNEUMATIC TIRE

(71) Applicant: Toyo Tire Corporation, Itami-shi (JP)

(72) Inventor: Ayana Uchida, Itami-shi (JP)

(73) Assignee: Toyo Tire Corporation, Itami-shi (JP)

(21) Appl. No.: 17/132,341

(22) Filed: Dec. 23, 2020

(30) Foreign Application Priority Data
Dec. 27, 2019 (JP) 2019-239131

(51) Int. Cl. C08L 15/00; B60C 1/00; C08L 23/22; C08L 7/00

(52) U.S. Cl. CPC C08L 15/00; B60C 1/00; C08K 3/06; C08L 7/00; B60C 2001/0066; C08L 23/22

(57) ABSTRACT

A pneumatic tire includes a rubber member A containing a sulfur and a rubber component containing 70 to 100% by mass of a hydrogenated copolymer obtained by hydrogenating an aromatic vinyl-conjugated diene copolymer, the hydrogenated copolymer having a weight average molecular weight of 300,000 or more and having a hydrogenation ratio of a conjugated diene moiety of 80 mol % or more, and a rubber member B containing a rubber component containing a diene rubber and sulfur, in which the rubber member A and the rubber member B are in contact with each other, and the sulfur content of the rubber member A is 0.25 vol % or more, and the sulfur content of the rubber member B is 0.25 vol % or more, and the total content of the sulfur content of the rubber member A and the sulfur content of the rubber member B is 0.7 vol % or more.

### BACKGROUND OF THE INVENTION

### 1. Field of the Invention

The present disclosure relates to a pneumatic tire.

### 2. Description of Related Art

It is known that a hydrogenated copolymer is used as a rubber material having high strength and excellent wear resistance. However, since the hydrogenated copolymer is hydrogenated with double bonds and has few crosslinking points, the copolymer has poor adhesiveness to other rubber members, and accordingly, there is a problem that defects such as peeling of members are likely to occur in the tire molding process.

As a method for improving the adhesiveness, JP-A-2011-105848 describes that a peroxide is used, and JP-A-2010-150502 describes that a sulfenamide type vulcanization accelerator having a specific structure is used.

However, when the methods described in JP-A-2011-105848 and JP-A-2010-150502 are applied to a rubber composition containing a hydrogenated copolymer, there is a problem that it is necessary to adjust the vulcanization rate and the high strength of the hydrogenated copolymer is impaired.

### SUMMARY OF THE INVENTION

In view of the above points, an object of the present disclosure is to provide a pneumatic tire having excellent adhesiveness between a rubber member containing a hydrogenated copolymer and a rubber member containing a diene rubber while maintaining the high strength of the hydrogenated copolymer.

In order to solve the problems described above, a pneumatic tire according to the present disclosure includes a rubber member A containing a rubber component and sulfur, the rubber component containing 70 to 100% by mass of a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and a rubber member B containing a rubber component containing a diene rubber and sulfur, in which the rubber member A and the rubber member B are in contact with each other at an interface, and the sulfur content of the rubber member A is 0.25 vol % or more, the sulfur content of the rubber member B is 0.25 vol % or more, and the total content of tire sulfur content of the rubber member A and the sulfur content of the rubber member B is 0.7 vol % or more.

The content of the diene rubber contained in the rubber component of the rubber member B can be 70 to 100% by mass.

According to the present disclosure, it is possible to obtain a pneumatic tire having excellent adhesiveness between a robber member containing a hydrogenated copolymer and a rubber member containing a diene rubber while maintaining the high strength of the hydrogenated copolymer.

### DESCRIPTION OF EMBODIMENTS

Hereinafter, matters related to the embodiments of the present disclosure will be described in detail.

### [Rubber Member A]

A rubber component of a rubber member A according to the present embodiment may contain a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more. In the present description, the “weight average molecular weight measured by gel permeation chromatography (GPC)” is a value calculated in terms of polystyrene based on the commercially available standard polystyrene using a differential refractive index detector (RI) as a detector and using tetrahydrofuran (THF) as a solvent under the conditions that a measurement temperature is 40° C., a flow rate is 1.0 mL/min, a concentration is 1.0 g/L and an injection amount is 40 μL. The hydrogenation ratio is a value calculated from a spectrum decrease rate of an unsaturated bond moiety of the spectrum obtained by measuring H¹-NMR.

The aromatic vinyl constituting the aromatic vinyl-conjugated diene copolymer is not particularly limited, and the examples thereof include styrene, α-methylstyrene, 1-vinylnaphthalene, 3-vinyltoluene, ethylvinylbenzene, divinylbenzene, 4-cyclohexylstyrene, 2,4,6-trimethylstyrene and the like. The aromatic vinyl may be used alone or as a combination of two or more kinds thereof.

The conjugated diene constituting the aromatic vinyl-conjugated diene copolymer is not particularly limited, and the examples thereof include 1,3-butadiene, isoprene, 1,3-pentadiene, 2,3-dimethylbutadiene, 2-phenyl-1,3-butadiene, 1,3-hexadiene and the like. The conjugated diene may be used alone or as a combination of two or more kinds thereof.

The aromatic vinyl-conjugated diene copolymer is not particularly limited, but a copolymer of styrene and 1,3-butadiene (styrene-butadiene copolymer) is preferred. Therefore, the hydrogenated copolymer is preferably a hydrogenated styrene-butadiene copolymer. The hydrogenated copolymer may be a random copolymer, may be a block copolymer and may be an alternating copolymer.

The hydrogenated copolymer can be synthesized by synthesizing an aromatic vinyl-conjugated diene copolymer and conducting a hydrogenation treatment, for example. A method of synthesizing the aromatic vinyl-conjugated diene copolymer is not particularly limited, and the examples thereof include a solution polymerization method, a gas phase polymerization method and a bulk polymerization method, and the solution polymerization method is particularly preferred. The polymerization form may be either a batch type or a continuous type. A commercially available aromatic vinyl-conjugated diene copolymer can be used.

The hydrogenation method is not particularly limited, and hydrogenation may be conducted by the known method under (he known conditions. The hydrogenation is generally conducted at 20 to 150° C. under a hydrogen pressure of 0.1 to 10 MPa in the presence of a hydrogenation catalyst. The hydrogenation ratio can be optionally adjusted by changing the amount of a hydrogenation catalyst, a hydrogen pressure when hydrogenating, reaction time, and the like. As the hydrogenation catalyst, a compound can be generally used which contains any of metals of groups 4 to 11 of the periodic table. For example, a compound containing Ti, V, Co, Ni, Zr, Ru, Rh, Pd, Hf, Re or Pt atom can be used as the hydrogenation catalyst. Examples of more specific hydrogenation catalysts include a metallocene compound containing, for example. Ti, Zr, Hf, Co, Ni, Pd, Pt, Ru, Rh or Re; a supported type heterogeneous catalyst including a carrier such as carbon, silica, alumina or diatomaceous earth and a metal such as Pd, Ni, Pt, Rh or Ru supported thereon; a homogeneous Ziegler catalyst including a combination of an organic salt or acetylacetone salt of a metal element such as Ni or Co and a reducing agent such as organic aluminum; an organic metal compound or complex of Ru, Rh, or the like; and fullerene or carbon nanotube having hydrogen occluded therein.

The hydrogenation ratio of the hydrogenated copolymer (proportion of hydrogenated portion in conjugated diene moiety of aromatic vinyl-conjugated diene copolymer) is 80 mol % or more, preferably 80 to 95 mol %. more preferably 85 to 95 mol %, and still more preferably 90 to 95 mol %. When the hydrogenation ratio is 80 mol % or more, the improvement effect of abrasion resistance due to homogenization of crosslinking is excellent.

The weight average molecular weight of the hydrogenated copolymer is not particularly limited so long as the weight average molecular weight is 300,000 or more, but is preferably 300,000 to 2,000,000, more preferably 300,000 to 1,000,000, and still more preferably 300,000 to 600,000.

The rubber component of the rubber member A may contain a diene rubber other than the hydrogenated copolymer, and may include, for example, natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. The diene rubbers can be used in one kind alone or as a blend of two or more kinds thereof.

The content ratio of the hydrogenated copolymer in the rubber component is not particularly limited, but is preferably 70 to 100% by mass, and more preferably 80 to 100% by mass.

The rubber member A contains a sulfur component as a vulcanizing agent as described above, such as powdered sulfur, precipitated sulfur, colloidal sulfur, insoluble sulfur and highly dispersible sulfur, and the content of the sulfur is 0.25 vol % or more, with respect to the rubber member A. When the sulfur is contained in the content described above, the adhesiveness between the rubber member A and the rubber member B is excellent.

### [Rubber Member B]

The rubber component used in the rubber member B according to the present embodiment contains a diene rubber, and the content ratio of the diene rubber in the rubber component is not particularly limited, but is preferably 70 to 100% by mass, and more preferably 80 to 100% by mass.

Examples of the diene rubber include natural rubber (NR), isoprene rubber (IR), butadiene rubber (BR). styrene-butadiene rubber (SBR), styrene-isoprene copolymer rubber, butadiene-isoprene copolymer rubber, and styrene-isoprene-butadiene copolymer rubber. The diene rubbers can be used in one kind alone or as a blend of two or more kinds thereof.

The rubber member B contains a sulfur component as a vulcanizing agent, such as powdered sulfur, precipitated sulfur, colloidal sulfur, insoluble sulfur and highly dispersible sulfur, and the content of the sulfur is 0.25 vol % or more, with respect to the rubber member B. When the sulfur is contained in the content described above, the adhesiveness between the rubber member A and the rubber member B is excellent.

The total content of the sulfur content of the robber member A and the sulfur content of the rubber member B is 0.7 vol % or more. When the sulfur is contained in the content described above, the adhesiveness between the rubber member A and the robber member B is excellent.

The pneumatic tire according to the present embodiment has excellent adhesiveness, when the rubber member A and the rubber member B, which are in contact with each other at an interface, contain a predetermined content of sulfur. Although the precise mechanism is not clear, it can be inferred as follows. Since the hydrogenated copolymer has a small amount of double bonds, when sulfur is blended at a normal content, before the sulfur and the double bond in the rubber member A contribute to the adhesiveness at the interface between the rubber member A and the rubber member B, they are consumed for crosslinking in the hydrogenated copolymer of the rubber member A. On the other hand, it can be inferred that in the present embodiment, since the number of sulfur radicals is increased by increasing the amount of sulfur to a higher level than usual, the chance of reacting with the double bond existing at the interface between the rubber member A and the rubber member B increases and a crosslinked structure is formed at the interface between the rubber member A and the rubber member B, so that excellent adhesiveness can be obtained.

### [Other Compounding Ingredients]

In the rubber member A and the rubber member B according to the present embodiment, in addition to the components described above, compounding ingredients used in the general rubber industry, such as reinforcing fillers, processing aids, zinc oxide, stearic acid, softeners, plasticizers, liquid rubbers, resins, waxes, age resisters, and vulcanization accelerators, can be suitably added within the ordinary range. The rubber member A and the rubber member B may have different formulations of the compounding ingredients.

Examples of the reinforcing filler include silica and carbon black, and silica and carbon black may be used in combination. That is, the reinforcing filler may be silica alone, carbon black alone, or a combination of silica and carbon black.

Preferably, silica and carbon black are used in combination. The content of the reinforcing filler is not particularly limited and is preferably 10 to 150 parts by mass, more preferably 20 to 100 parts by mass, and still more preferably 30 to 80 parts by mass, with respect to 100 parts by mass of the rubber component.

The silica is not particularly limited, but wet silica such as wet precipitated silica or wet gelled silica is preferably used. The content of silica is 1 to 150 parts by mass and preferably 1 to 100 parts by mass with respect to 100 parts by mass of the rubber component.

A silane coupling agent such as sulfide silane or mercaptosilane may be further contained. When the silane coupling agent is contained, the content thereof is preferably 2 to 20% by mass with respect to the silica content.

The carbon black is not particularly limited, and various known kinds thereof can be used. The content of carbon black is preferably 1 to 70 parts by mass, and more preferably 1 to 30 parts by mass with respect to 100 parts by mass of the rubber component.

Examples of the vulcanization accelerator include a sulfenamide type vulcanization accelerator, a guanidine type vulcanization accelerator, a dithiocarbamate type vulcanization accelerator, a thiuram type vulcanization accelerator, a thiazole type vulcanization accelerator, a thiourea type vulcanization accelerator, and the like. Among these, the sulfenamide type vulcanization accelerator, the guanidine type vulcanization accelerator and the dithiocarbamate type vulcanization accelerator are preferred.

Examples of the sulfenamide type vulcanization accelerator include N-cyclohexyl-2-benzothiazolyl sulfenamide (CZ), N-tert-butyl-2-benzothiazolyl sulfenamide (NS), N-oxydiethylene-2-benzothiazolyl sulfenamide (MBS) and N,N-diisopropyl-2-benzothiazolesulfenamide (DZ), and the like.

Examples of the guanidine type vulcanization accelerator include 1.3-diphenylguanidine (D) and di-O-tolylguanidine (DT).

Examples of the dithiocarbamate type vulcanization accelerator include zinc dibenzyldithiocarbamate (ZnBzDTC), zinc dimethyldithiocarbamate (ZnMDC), zinc diethyldithiocarbamate (ZnEDC), zinc di-n-butyldithiocarbamate (ZnBDC), zinc N-pentamethylenedithiocarbamate (ZoPDC), zinc ethylphenyldithiocarbamate (ZnEPDC), sodium dimethyldithiocarbamate (NaMDC), sodium diethyldithiocarbamate (NaEDC), sodium di-n-butyldithiocarbamate (NaBDC), tellurium diethyldithiocarbamate (TeEDC), copper dimethyldithiocarbamate (CuMDC), iron dimethyldithiocarbamate (FeMDC), and the like.

When the sulfenamide type vulcanization accelerator is contained, the content thereof is not particularly limited, but is preferably 0.1 to 3 parts by mass and more preferably 0.2 to 2 parts by mass with respect to 100 parts by mass of the rubber component.

When the guanidine type vulcanization accelerator is contained, the content thereof is not particularly limited, but is preferably 0.1 to 3 parts by mass and more preferably 0.2 to 2 parts by mass with respect to 100 parts by mass of the rubber component.

When the dithiocarbamate type vulcanization accelerator is contained, the content thereof is not particularly limited, but is preferably 0.1 to 3 parts by mass, and more preferably 0.2 to 2 parts by mass with respect to 100 parts by mass of the rubber component.

In the rubber member A, it is preferable to use the dithiocarbamate type vulcanization accelerator and the guanidine type vulcanization accelerator in combination, and the blending ratio (guanidine type vulcanization accelerator / dithiocarbamate type vulcanization accelerator) is preferably 0.5 to 3.0 in terms of mass ratio.

The total content of the vulcanization accelerators in each rubber member is preferably 0.1 to 9 parts by mass, and more preferably 0.5 to 6 parts by mass with respect to 100 parts by mass of the rubber component.

The rubber composition according to the present embodiment can be produced by kneading with a commonly used mixing machine, such as a Banbury mixer, a kneader, or a roll, according to a method of the related arts. That is, in a first mixing step, additives other than the vulcanizing agent and the vulcanization accelerator are added and mixed with the rubber component, and then, in a final mixing step, the vulcanizing agent and the vulcanization accelerator are added and mixed with the resultant mixture, and thereby a rubber composition can be produced.

The rubber composition thus obtained can be used for tires, and can be applied to various sites of the tires such as treads and sidewalls of pneumatic tires of various uses and sizes such as tires for passenger cars, and large size tires for trucks and buses. The rubber composition is molded into the rubber member A and tire rubber member B in a predetermined shape by, for example, extrusion processing according to the method of the related arts, combined with other parts and then vulcanized at 140 to 180° C., for example, and thereby a pneumatic tire can be produced.

The application site is not particularly limited so long as the rubber member A and the rubber member B are m contact with each other at the interface, and for example, in a tread portion having a base rubber arranged outside in a tire radial direction of the belt layer and a cap rubber arranged outside in the tire radial direction of the base rubber, the rubber member A may be used as the cap rubber and the rubber member B may be used as the base rubber, and in a tread portion where different rubber members are arranged in the width direction, the inside part (inner side of the vehicle when the tires are mounted) may be the rubber member A, and the outside part (outer side of the vehicle when the tires are mounted) may be the rubber member B, or the outside part may be the rubber member A, and the inside part may be the rubber member B. The application site of the rubber member A may be a tread portion, and the application site of the rubber member B may be a shoulder portion, a side portion, or a belt layer.

The type of the pneumatic tire according to the present embodiment is not particularly limited, and the examples thereof include various tires such as passenger car tires and heavy-duty tires used for trucks, buses, and the like.

### EXAMPLES

Hereinafter, certain examples of die present disclosure are described below, but the present disclosure is not construed as being limited to these examples.

### <Synthesis Example of Hydrogenated Copolymer 1>

2.5 L of cyclohexane, 50 g of tetrahydrofuran (THF), 0.12 g of n-butyllithium, 100 g of styrene and 400 g of 1,3-butadiene were put in a nitrogen-substituted heat-resistant reaction vessel, and polymerization was conducted at a reaction temperature of 50° C. After completion of the polymerization, 1.7 g of N,N-bis(trimethylsilyl)aminopropylmethyl diethoxylan was added, a reaction was conducted for 1 hour and hydrogen gas was then supplied under a pressure of 0.4 MPa-gauge and the resultant was stirred for 20 minutes. Next, the reaction was conducted at a reaction temperature of 90° C. under a hydrogen gas supply pressure of 0.7 MPa-gauge using a catalyst mainly including titanocene dichloride until reaching a desired hydrogenation ratio, and solvent was removed to obtain hydrogenated copolymer 1.

The hydrogenated copolymer 1 obtained had a weight average molecular weight of 350,000 in terms of polystyrene by standard polystyrene, using “LC-10A” manufactured by Shimadzu Corporation as a measuring instrument, using “PLgel-MIXED-C” manufactured by Polymer Laboratories as a column, using a differential refractive index detector (RI) as a detector and using THF as a solvent under conditions of a measurement temperature of 40° C., a flow rate of 1.0 mL/min, a concentration of 1.0 g/L, and an injection amount of 40 μL. The amount of bonded styrene was 20% by mass, and the hydrogenation ratio of the butadiene moiety was 90 mol %. The amount of styrene bonded was obtained from a spectrum intensity ratio of proton based on styrene unit and proton based on butadiene unit (including hydrogenated portion) using H¹-NMR.

### <Examples and Comparative Examples>

Using a Banbury mixer, components excluding a vulcanization accelerator and sulfur were added according to the formulations (parts by mass) shown in Table 1 below, followed by mixing, in a first mixing step (non-processing kneading step) (discharge temperature=160° C.), and then a vulcanization accelerator and sulfur were added to the mixture obtained, followed by mixing, in a final mixing step (processing kneading step) (discharge temperature=90° C.) so that a rubber composition was prepared.

The details of each components in Table 1 are as follows.

Hydrogenated SBR1: Hydrogenated copolymer 1 prepared according to the Synthesis Example 1

ESBR: “SBR1502” manufactured by JSR Corporation, emulsion-polymerized styrene-butadiene rubber, weight average molecular weight=420,000

Modified SSBR: “HPR350” manufactured by JSR Corporation styrene content 21% by mass, alkoxy group and amino group terminal modified solution polymerization SBR

NR: RSS #3 glass transition point=−60° C.

BR: “BR150B” manufactured by Ube Industry, Co., Ltd.

Silica: “Ultrasil VN3” manufactured by Evonik Japan

Silane coupling agent: “Si69” manufactured by Evonik Japan

Carbon black: “SEAST 3” manufactured by Tokai Carbon Co., Ltd.

Aroma oil: “Process NC140” manufactured by JXTG Nippon Oil & Energy Corporation

Zinc oxide: “Zinc Oxide 2 Species” manufactured by Mitsui Mining & Smelting Co., Ltd.

Age resister: “Antigen 6C” manufactured by Sumitomo Chemical Co., Ltd.

Stearic acid: “LUNAC S-20” manufactured by Kao Corporation

Wax: “OZOACE 0355” manufactured by Nippon Seiro Co., Ltd.

Resin: C5/C9 petroleum resin. “Petrotack 90” manufactured by Tosoh Co., Ltd.

Vulcanization accelerator 1: Sulfanamide type vulcanization accelerator, “SOXINOL CZ” manufactured by Sumitomo Chemical Co., Ltd.

Vulcanization accelerator 2: Guanidine type vulcanization accelerator, “NOCCELER D” manufactured by Ouchi Shinko Chemical Industrial Co., Ltd.

Vulcanization accelerator 3: Dithiocarbamate type vulcanization accelerator, “Sanceler Z-BE” manufactured by Sanshin Chemical Industry Co., Ltd.

Sulfur “Powdered Sulfur” manufactured by Tsurumi Chemical Industry Co., Ltd., specific gravity=2

TABLE 1

| | Formulation A | | | | | | Formulation B | | | |
|---|---|---|---|---|---|---|---|---|---|---|
| | A-1 | A-2 | A-3 | A-4 | A-5 | A-6 | B-1 | B-2 | B-3 | B-4 |
| Hydrogenated | 100 | 100 | 100 | 100 | 100 | 100 | — | — | — | — |
| SBR1 | | | | | | | | | | |
| ESBR | — | — | — | — | — | — | 70 | 70 | — | — |
| Modified SBR | — | — | — | — | — | — | 30 | 30 | — | — |
| NR | — | — | — | — | — | — | — | — | 70 | 70 |
| BR | — | — | — | — | — | — | — | — | 30 | 30 |
| Silica | 50 | 50 | 50 | 50 | 50 | 50 | 100 | 100 | — | — |
| Silane | 4 | 4 | 4 | 4 | 4 | 4 | 8 | 8 | — | — |
| coupling agent | | | | | | | | | | |
| Carbon black | 5 | 5 | 5 | 5 | 5 | 5 | 20 | 20 | 60 | 35 |
| Aroma oil | 30 | 30 | 30 | 30 | 30 | 30 | 40 | 40 | 20 | — |
| Zinc oxide | 2.0 | 2.0 | 2.0 | 2.0 | 2.0 | 2.0 | 2.0 | 2.0 | 2.0 | 2.0 |
| Age resister | 2.0 | 2.0 | 2.0 | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 | 2.0 | 2.0 | 2.0 |
| Wax | 2.0 | 2.0 | 2.0 | 2.0 | 2.0 | 2.0 | 2.0 | 2.0 | 2.0 | 2.0 |
| Resin | — | — | — | — | — | — | 10 | 10 | 5 | — |
| Vulcanization | 0.5 | 0.5 | 0.5 | 0.5 | 0.5 | 0.5 | 2.0 | 2.0 | 1.0 | 2.0 |
| accelerator 1 | | | | | | | | | | |
| Vulcanization | 1.0 | 1.0 | 1.0 | 1.0 | 1.0 | 1.0 | 2.0 | 2.0 | — | — |
| accelerator 2 | | | | | | | | | | |
| Vulcanization | 0.8 | 0.8 | 0.8 | 0.8 | 0.8 | 0.8 | — | — | — | — |
| accelerator 3 | | | | | | | | | | |
| Sulfur | 0.6 | 1.0 | 1.6 | 2.0 | 4.5 | 6.7 | 1.0 | 1.5 | 2.0 | 2.8 |
| Sulfur vol % | 0.2 | 0.3 | 0.5 | 0.6 | 1.3 | 1.9 | 0.2 | 0.3 | 0.6 | 1.0 |

The rupture strength of each obtained rubber composition of Formulation A was evaluated. The obtained rubber compositions of Formulation A and the rubber compositions of Formulation B were adhered in the combination shown in Table 3, and the adhesiveness was evaluated using a sample vulcanized at 160° C. for 30 minutes. The measurement and evaluation methods are as follows, and Table 2 shows the evaluation results of rupture strength, and Table 3 shows the evaluation results of adhesiveness.

Rupture strength: A tensile test (Dumbbell-shape No. 3) was conducted according to JIS K6251 to measure tensile strength, and the tensile strength was indicated as an index using the value of Comparative Example 1 being set at 100. Larger value indicates higher rupture strength and were excellent reinforcing property.

Adhesiveness: A strip of rubber sample A of formulation A and a strip of rubber sample B of formulation B were overlapped and vulcanized at 160° C. for 30 minutes with a PET film partially interposed therebetween to bond the rubber sample A and the rubber sample B. After vulcanization, non-adhered portions of the rubber sample A and the rubber sample B were gripped by “Autograph DCS500” manufactured by Shimadzu Corporation, and the bonded rubber sample was peeled off at a peeling speed of 50 mm/min so as to form a T shape. After peeling, in the case where the peeled cross section exhibits rubber fracture, the rubber sample A and the rubber sample B were evaluated as “good” because they have excellent adhesiveness, and in the case of interfacial peeling, the rubber sample A and the rubber sample B were evaluated as “bad” because they were inferior in adhesiveness.

TABLE 2

| | Formulation A | | | | | |
|---|---|---|---|---|---|---|
| | A-1 | A-2 | A-3 | A-4 | A-5 | A-6 |
| Rupture strength | 100 | 110 | 113 | 111 | 108 | 104 |

TABLE 3

| | Com. 1 | Com. 2 | Com. 3 | Ex. 1 | Ex. 2 | Ex. 3 | Ex. 4 | Ex. 5 |
|---|---|---|---|---|---|---|---|---|
| Fommlation A | A-1 | A-2 | A-4 | A-2 | A-2 | A-3 | A-5 | A-6 |
| Formulation B | B-3 | B-2 | B-1 | B-3 | B-4 | B-2 | B-2 | B-2 |
| Sulfur vol. % of | 0.2 | 0.3 | 0.6 | 0.3 | 0.3 | 0.5 | 1.3 | 1.9 |
| Formulation A | | | | | | | | |
| Sulfur vol % of | 0.6 | 0.3 | 0.2 | 0.6 | 1.0 | 0.3 | 0.3 | 0.3 |
| Formulation B | | | | | | | | |
| Total of sulfur vol % | 0.8 | 0.6 | 0.8 | 0.9 | 1.3 | 0.8 | 1.6 | 2.2 |
| Adhesiveness | bad | bad | bad | bood | bood | bood | bood | bood |

The results are as shown in Table 2, and from the comparison between Formulation A-1 and the Formulations A-2 to A-6, it can be seen that the rupture strength of the rubber member A was improved when the sulfur content was increased. As shown in Table 3, excellent adhesiveness was obtained in Examples 1 to 5.

Comparative Example 1 is an example in which the sulfur content of the rubber member A is out of the predetermined range, and the adhesiveness is inferior.

Comparative Example 2 is an example in which the total content of tire sulfur content of the rubber member A and the sulfur content of the rubber member B is out of the predetermined range, and the adhesiveness is inferior.

Comparative Example 3 is an example in which the sulfur content of tire rubber member B is out of the predetermined range, and the adhesiveness is inferior.

The pneumatic tire of the present disclosure can be used as various tires for passenger cars, light duty trucks and buses and the like.

What is claimed is:

1. A pneumatic tire comprising:
a rubber member A containing a rubber component and sulfur, the rubber component containing 70 to 100% by mass of a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more; and
a rubber member B containing a rubber component containing a diene rubber and sulfur, wherein
the rubber member A and the rubber member B are in contact with each other at an interface, and
a sulfur content of tire rubber member A is 0.25 vol % or more, a sulfur content of the rubber member B is 0.25 vol % or more, and the total content of the sulfur content of the rubber member A and the sulfur content of the rubber member B is 0.7 vol % or more.

2. The pneumatic tire according to claim 1, wherein a content of the diene rubber contained in the rubber component of the rubber member B is 70 to 100% by mass.
